(19) United States
(12) Patent Application Publication
(10) Pub. No.: US 2014/0195014 A1
(43) Pub. Date: Jul. 10, 2014

(54) ELECTRONIC APPARATUS AND METHOD FOR CONTROLLING ELECTRONIC APPARATUS

(71) Applicant: SAMSUNG ELECTRONICS CO., LTD., SUWON-SI (KR)

(72) Inventors: Dong-heon LEE, Seoul (KR); Jung-geun KIM, Suwon-si (KR); Sung-hyun JANG, Seoul (KR); Jae-kwon KIM, Suwon-si (KR)

(73) Assignee: SAMSUNG ELECTRONICS CO., LTD., SUWON-SI (KR)

(21) Appl. No.: 14/084,696

(22) Filed: Nov. 20, 2013

(30) Foreign Application Priority Data
Jan. 4, 2013 (KR) 10-2013-0001253

(51) Int. Cl. G05B 15/02

(52) U.S. Cl. CPC G05B 15/02
USPC 700/83

(57) ABSTRACT

An electronic apparatus and a method for controlling an electronic apparatus that includes receiving a user motion command, in response to the receiving the user motion command, displaying information regarding a motion task corresponding to the received user motion command, and performing the motion task corresponding to the received user motion command after the information regarding the motion task has been displayed for a predetermined time.

### CROSS-REFERENCE TO RELATED APPLICATION

This application claims priority from Korean Patent Application No. 10-2013-1253, filed in the Korean Intellectual Property Office on Jan. 4, 2013, the disclosure of which is incorporated herein by reference.

### BACKGROUND

1. Field

Methods and apparatuses consistent with exemplary embodiments relate to an electronic apparatus and a method for controlling an electronic apparatus, and more particularly, to an electronic apparatus which is controlled by an input user motion and a method for controlling an electronic apparatus.

2. Description of the Related Art

Recently, with the development of electronic technology, various types of display apparatuses have been developed. In particular, various types of display apparatuses including a television have been used in households. Such display apparatuses are providing more and more functions in accordance with users' increasing needs. In particular, a television may now be connected to Internet, and may even provide Internet services. In addition, a user may watch a plurality of digital broadcasting channels through a television.

Accordingly, various input methods are required to effectively use various functions of a display apparatus. For example, various input methods such as an input method using a remote controller, a mouse, and a touch pad may be used with an electronic apparatus.

However, there are difficulties in utilizing various functions of a display apparatus with such simple input methods.

For example, when all of the functions of a display apparatus are controlled by a remote controller, it is inevitable that the number of buttons of the remote controller will increase. In this case, it is not easy for a general user to become familiar with the method for using such a remote controller. Alternatively, when various menus are displayed on the screen for a user to search and select from, the user needs to check all of the complicated menu trees in order to find a desired menu item, causing inconvenience to the user.

In order to resolve the above problems, recently, motion recognition technology which allows a user to control an electronic apparatus more conveniently and intuitively has been developed. That is, the technology of controlling an electronic apparatus by recognizing a user motion has come into the spotlight these days.

However, in the related art motion recognition technology, a user may not recognize which function is performed by the user motion before the corresponding function is actually performed and thus the user may feel uncomfortable about using the motion recognition technology.

### SUMMARY

An aspect of the exemplary embodiments relates to an electronic apparatus which provides information regarding an input motion in advance and a method for controlling an electronic apparatus.

A method for controlling an electronic apparatus according to an exemplary embodiment includes receiving a user motion command, in response to the receiving the user motion command, displaying information regarding a motion task corresponding to the received user motion command, and performing the motion task corresponding to the received user motion command after the information regarding the motion task has been displayed for a predetermined time.

The performing the motion task may include, in response to a motion input corresponding to the user motion command being maintained until the predetermined time after the information regarding the motion task is displayed has elapsed, performing the motion task.

The method may further include, in response to a motion input corresponding to the user motion command being released before the predetermined time after the information regarding the motion task is displayed has elapsed, canceling execution of the motion task.

The displaying the information regarding the motion task may include providing feedback regarding a remaining time of the predetermined time after which the motion task will be performed.

The method may further include, in response to the user motion command being input, displaying a first GUI element which provides visual feedback regarding a recognized user motion, and the displaying the information regarding the motion task may include displaying a second GUI element which represents the information regarding the motion task in association with the displayed first GUI element.

The second GUI element may include an icon representing a function which will be performed according to the motion task.

The second GUI element may further include a graphic element representing a remaining time of the predetermined time after which the motion task will be performed.

The icon included in the second GUI may be displayed inside a circular element, and the graphic element included in the second GUI may be displayed outside the circular element at a border area of the circular element.

An electronic apparatus according to an exemplary embodiment includes a motion input unit configured to receive a user motion command, a display, and a controller which, in response to the user motion command being received by the motion input unit, is configured to control the display to display information regarding a motion task corresponding to the user motion command received by the motion input unit and perform the motion task corresponding to the user motion command received by the motion input unit after the information regarding the motion task has been displayed for a predetermined time.

The controller, in response to a motion input corresponding to the user motion command being maintained until the predetermined time after the information regarding the motion task is displayed has elapsed, may be configured to perform the motion task.

The controller, in response to a motion input corresponding to the user motion command being released before the predetermined time after the information regarding the motion task is displayed has elapsed, may be configured to cancel execution of the motion task.

The controller may be configured to provide feedback regarding a remaining time of the predetermined time after which the motion task will be performed.

The controller, in response to the user motion being input, may be configured to display a first GUI element which provides visual feedback regarding a recognized user motion, and display a second GUI element which represents the information regarding the motion task in association with the displayed first GUI element.

The second GUI element may include an icon representing a function which will be performed according to the motion task.

The second GUI element may further include a graphic element representing a remaining time of the predetermined time after which the motion task will be performed.

According to another exemplary embodiment, a non-transitory computer readable medium storing a program causing a computer to execute a method for controlling an electronic apparatus includes receiving a user motion command, in response to the receiving the user motion command, displaying information regarding a motion task corresponding to the received user motion command, and performing the motion task corresponding to the received user motion command after the information regarding the motion task has been displayed for a predetermined time.

The performing the motion task may include, in response to a motion input corresponding to the user motion command being maintained until the predetermined time after the information regarding the motion task is displayed has elapsed, performing the motion task.

The non-transitory computer readable medium may further include, in response to a motion input corresponding to the user motion command being released before the predetermined time after the information regarding the motion task is displayed has elapsed, canceling execution of the motion task.

The displaying the information regarding the motion task may include providing feedback regarding a remaining time of the predetermined time after which the motion task will be performed.

The non-transitory computer readable medium may further include, in response to the user motion command being input, displaying a first GUI element which provides visual feedback regarding a recognized user motion, wherein the displaying the information regarding the motion task may include displaying a second GUI element which represents the information regarding the motion task in association with the displayed first GUI element.

As described above, a user may be provided with information regarding a function which will be performed according to his or her motion in advance, and thus the user's cognitive anxiety may be reduced.

### BRIEF DESCRIPTION OF THE DRAWINGS

The above and other aspects will be more apparent by describing certain exemplary embodiments with reference to the accompanying drawings, in which:

FIG. 1 is a schematic view illustrating an electronic apparatus according to an exemplary embodiment;

FIG. 2 is a block diagram illustrating a configuration of an electronic apparatus according to an exemplary embodiment;

FIG. 3 is a block diagram illustrating a configuration of an electronic apparatus according to another exemplary embodiment;

FIG. 4 is a view illustrating a configuration of software stored in storage according to an exemplary embodiment;

FIGS. 5 and 6 are views illustrating a method for providing a user interface (UI) according to an exemplary embodiment;

FIG. 7 is a view illustrating a method for providing a UI according to another exemplary embodiment;

FIG. 8 is a view illustrating a method for providing a UI according to another exemplary embodiment;

FIG. 9 is a flowchart illustrating a method for controlling an electronic apparatus according to an exemplary embodiment; and

FIG. 10 is a flowchart illustrating a method for controlling an electronic apparatus according to another exemplary embodiment.

### DETAILED DESCRIPTION

Certain exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of exemplary embodiments. However, exemplary embodiments may be practiced without those specifically defined matters. Also, well-known functions or constructions are not described in detail since they would obscure the application with unnecessary detail.

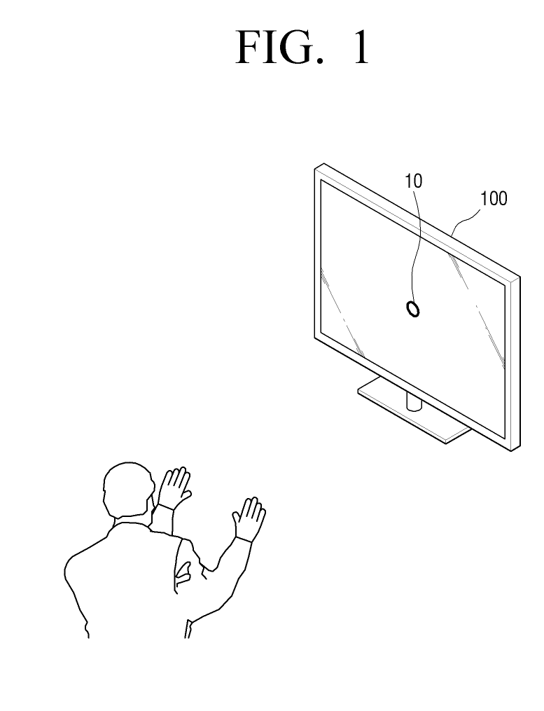

FIG. 1 is a schematic view illustrating an electronic apparatus according to an exemplary embodiment.

An electronic apparatus 100 may sense a user motion, and may be realized as a digital television which is controlled by the sensed motion. However, the electronic apparatus 100 may be realized as any apparatus which is capable of recognizing a user motion, such as a PC monitor.

Once a user motion is sensed, the electronic apparatus 100 may generate motion information according to the sensed motion, change the generated information to a control signal to control the electronic apparatus 100, and then perform a function based on the control signal.

In particular, the electronic apparatus 100 may reduce motion recognition errors by providing feedback regarding the sensed user motion to the user. In this case, the feedback may include at least one of feedback regarding the pose of the sensed motion and feedback regarding a function performed by the sensed motion.

Hereinafter, the specific operations of the electronic apparatus 100 will be described with reference to the corresponding drawings.

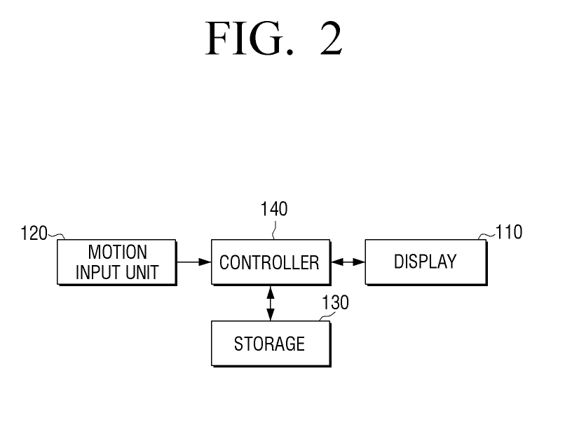

FIG. 2 is a block diagram illustrating a configuration of the electronic apparatus 100 according to an exemplary embodiment. Referring to FIG. 1, the electronic apparatus 100 comprises a display 110, a motion input unit 120, a storage 130, and a controller 140. The electronic apparatus 100 may be a smart television, but this is only an example. The electronic apparatus 100 may be realized as various electronic apparatuses such as a smart phone, a tablet PC, a notebook PC, and so on.

The display 110 displays an image signal input from various sources. For example, the display 110 may display an image corresponding to a broadcast signal received through a broadcast receiver. In addition, the display 110 may display image data (for example, video) input through an external terminal input unit (not shown).

Further, the display 110 may display a UI screen corresponding to a motion task mode. For example, the display 110 may display a screen including a pointer 10, as shown in FIG. 1, to perform a motion task function in the motion task mode. Herein, the pointer may be a graphical user interface (GUI) in a circle form.

The motion input unit 120 receives an image signal (for example, successive frames) photographing a user motion and provides the image signal to the controller 140. For example, the motion input unit 120 may be implemented as a camera unit including a lens and an image sensor. In addition, the motion input unit 120 may be formed integrally with the electronic apparatus 100 or separately from the electronic apparatus 100. When the motion input unit 120 is provided separately from the electronic apparatus 100, the motion input unit 120 may be connected to the electronic apparatus 100 via a cable or wirelessly.

The storage 130 stores various data and programs to drive and control the electronic apparatus 100. The storage 130 stores a motion recognition module to recognize a motion input through the motion input unit 120. In addition, the storage 130 may include a motion database. In this case, the motion database refers to a database where a predetermined motion and a motion task corresponding to the predetermined motion are stored.

The controller 140 controls the display 110, the motion input unit 120, and the storage 130. The controller may include a central processing unit (CPU), read only memory (ROM), and random access memory (RAM) which store modules and data to control the electronic apparatus 100.

Once the motion of the electronic apparatus 100 is converted to a motion task mode, the controller 140 may display a pointer to perform a motion task function at a specific location on the display screen (for example, at the center of the screen).

In addition, if a motion is input through the motion input unit 120, the controller 140 recognizes the motion using a motion sensing module and the motion database. The motion recognition may be performed by dividing an image corresponding to the user motion input through the motion input unit 120 (for example, successive frames) into a background area and a hand area (for example, an area where a hand is open or clenched) and recognizing the successive movement of the hand using the motion recognition module. If a user motion is input, the controller 140 stores the received image by frame unit, and senses the object of the user motion (for example, a user hand) using the stored frames. The controller 140 detects the object by sensing at least one of shape, color, and movement of the object included in the frames. The controller 140 may trace the movement of the detected object using the location of each object included in a plurality of frames.

The controller 140 determines a motion according to the shape and movement of the traced object. For example, the controller 140 determines a user motion using at least one of change in the shape of the object, speed, location, and direction. The user motions recognized by the controller 140 may include a ‘grab’ motion which is the motion of clenching a hand, a ‘pointer move’ motion which is the motion of moving a displayed cursor using a hand, a ‘slap’ motion which is the motion of moving a hand in one direction at a speed that is higher than a certain speed, a ‘shake’ motion which is the motion of shaking a hand left/right or up/down, and a ‘rotate’ motion which is the motion of rotating a hand. However, the technical feature of the present embodiment may also be applied to other motions than the above-described motions. For example, the user motions recognized by the controller 140 may further include a ‘spread’ motion which is the motion of spreading a clenched hand.

In order to determine whether a user motion is a ‘pointer move’ motion or a ‘slap’ motion, the controller 140 determines whether an object moves beyond a predetermined area (for example, a square of 40 cm×40 cm) within a predetermined time (for example, 800 ms). If the object does not move beyond the predetermined area within the predetermined time, the controller 140 may determine that the user motion is a ‘pointer move’ motion. However, if the object moves beyond the predetermined area within the predetermined time, the controller 140 may determine that the user motion is a ‘slap’ motion. In another example, if it is determined that the speed of an object is below a predetermined speed (for example, 30 cm/s), the controller 140 may determine that the user motion is a ‘pointer move’ motion. If it is determined that the speed of the object exceeds the predetermined speed, the controller 140 determines that the user motion is a ‘slap’ motion.

In particular, when a user motion is recognized, the controller 140 may display information regarding a motion task corresponding to the recognized motion. Herein, the information regarding the motion task may be information regarding a function which will be executed as a result of the recognized motion. For example, if the function of “moving to a home screen” will be executed as a result of a recognized hand motion, a GUI representing the home screen may be displayed.

In addition, when a predetermined time has elapsed after the information regarding the motion task information is displayed, the motion task corresponding to the recognized motion may be executed. In this case, the controller 140 may perform the corresponding motion task when the motion input corresponding to the recognized motion is maintained for a predetermined time.

Meanwhile, the controller 140 may display a first GUI element which provides visual feedback regarding a pose of a recognized motion during a predetermined time before a motion task is performed after the user motion is recognized. Accordingly, a user may check how his or her motion is recognized in by display apparatus 100.

In this case, the controller 140 may display a second GUI element representing information regarding the motion task in association with the first GUI element which provides visual feedback of the pose of the recognized motion. In this case, the second GUI element may include an icon representing the function which is performed by the motion task.

In other words, the controller 140 may provide visual feedback regarding a pose of a recognized motion before displaying information regarding a motion task, thereby reducing cognitive anxiety of a user in the process of recognizing the pose.

In addition, the controller 140 may provide a feedback regarding a remaining time of the predetermined time until a motion task corresponding to a recognized motion will be performed.

Specifically, the controller 140 may display not only an icon representing a function performed in accordance with a motion task but also a graphic element representing a remaining time of the predetermined time until the motion task will be performed in the second GUI element which represents information regarding the motion task. For example, the icon representing a function which is performed in accordance with a motion task may be displayed inside a circular GUI, and the graphic element representing a remaining time of the predetermined time until the motion task will be performed may be displayed outside the circular GUI at the border area of the GUI. The graphic element representing the remaining time of the predetermined time until the motion task will be executed may be configured to have an animation effect where the remaining time is reduced gradually.

Further, when the motion input is canceled before the predetermined time has elapsed after information regarding the motion task is displayed, the controller 140 may cancel the execution of the motion task.

That is, the controller 140 may perform the motion task only when the corresponding motion input is maintained (i.e., not canceled) for a predetermined time, instead of performing the corresponding motion task immediately after the motion input is recognized according to a user motion command. Therefore, a user may recognize the function which will be performed according to the user motion in advance and may cancel the function before the function is performed, thereby reducing cognitive anxiety.

Meanwhile, according to an exemplary embodiment, a graphic element representing a remaining time of the predetermined time until a motion task is performed may be included and displayed in the first GUI element which provides visual feedback regarding a recognized motion. For example, the first GUI element which provides visual feedback regarding a recognized motion may be displayed inside a circular GUI, and the graphic element representing a remaining time of the predetermined time until the motion task is performed may be displayed outside the circular GUI at the border area of the GUI.

Therefore, if a different pose from a currently-recognized pose is recognized before the predetermined standby time has expired, a function corresponding to the different pose may be performed, and if a motion operation corresponding to the currently-recognized pose stops, the recognition of the corresponding motion operation may be canceled.

Subsequently, the controller 140 performs a task of the electronic apparatus 100 using the recognized motion. That is, the controller 140 may perform the task corresponding to the recognized motion when the recognized motion input is maintained after the predetermined time has elapsed after recognition of the motion. Herein, the task of the electronic apparatus 100 may include at least one of the functions performed by the electronic apparatus 100 such as moving to a home screen, changing channels, controlling volume, playing back contents (for example, video, music, photo, etc.) and performing Internet browsing.

Meanwhile, in the above exemplary embodiment, the first GUI element which provides visual feedback regarding a recognized motion may be displayed in association with the second element which represents information regarding a motion task, but this is only an example. According to another exemplary embodiment, the first GUI element and the second GUI element may be displayed separately. For example, the first GUI element may be displayed and then disappear, and subsequently the second GUI element may be displayed, or the second GUI element may be displayed while the first GUI element is displayed.

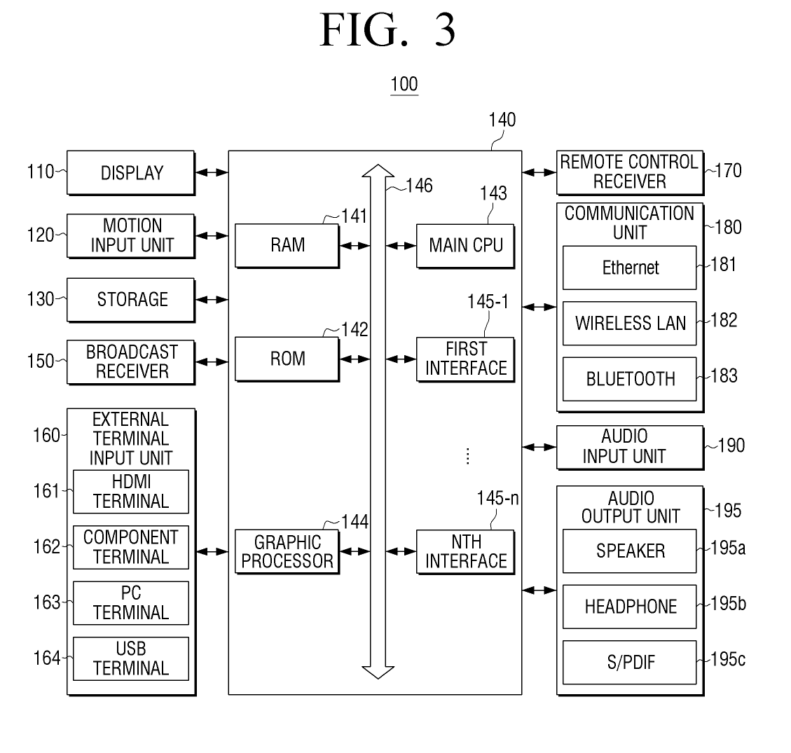

FIG. 3 is a block diagram illustrating a configuration of the electronic apparatus 100 according to another exemplary embodiment. Referring to FIG. 3, the electronic apparatus 100 includes the display 110, the motion input unit 120, the storage 130, the controller 140, a broadcast receiver 150, an external terminal input unit 160, a remote control signal receiver 170, a communication unit 180, a voice input unit 190, and an audio output unit 195.

Meanwhile, the detailed description regarding the components which are discussed above with regard to FIG. 2 will not be provided.

The controller 140 may include a RAM 141, a ROM 142, a main CPU 143, a graphic processor 144, first to nth interfaces 145-1-145-n, and a bus 146.

The RAM 141, the ROM 142, the main CPU 143, the graphic processor 144, and the first to nth interfaces 145-1-145-n may be connected to each other through the bus 146.

The first to nth interfaces 145-1-145-n are connected to the above-described components. One of the interfaces may be a network interface which is connected to an external apparatus via a network.

The main CPU 143 may access the storage 130 and perform booting using an operating system (OS) stored in the storage 130. In addition, the main CPU 143 may perform various operations using various programs, contents, and data stored in the storage 130.

The ROM 142 may store a set of commands for system booting. If a turn-on command is input and thus, power is supplied, the main CPU 143 may copy an OS stored in the storage 130 into the RAM 141 according to a command stored in the ROM 142 and execute the OS to boot the system. Once the system booting is completed, the main CPU 143 may copy various application programs stored in the storage 130 into the RAM 141 and perform various operations by executing the application programs copied into the RAM 141.

The graphic processor 144 may generate a screen including various objects such as icons, images, text, etc. using an operator (not shown) and a renderer (not shown). The operator (not shown) may calculate property values such as coordinates, shape, size, color, etc. of a screen where each object is displayed according to a layout of the screen. The renderer (not shown) may generate a screen including various layouts including an object based on the property values calculated by the operator. The screen generated by the renderer (not shown) may be displayed within a display area of the display 110.

The broadcast receiver 150 may receive a broadcast signal from outside via cable or wirelessly. The broadcast signal may comprise video, audio, and additional data such as electronic program guide (EPG) data. The broadcast receiver 150 may receive a broadcast signal from various sources such as a terrestrial broadcast, a cable broadcast, a satellite broadcast, an Internet broadcast, and so on.

The external terminal input unit 160 may receive image data (for example, video, photo, and so on), audio data (for example, music, and so on), etc. from outside of the electronic apparatus 100. The external terminal input unit 160 may include at least one of a High-Definition Multimedia Interface (HDMI) input terminal, a component input terminal, a PC input terminal, and a USB input terminal. The remote control signal receiver 170 may receive a remote control signal input from an external remote controller. The remote control signal receiver 170 may receive a remote control signal even when the electronic apparatus 100 is in an audio task mode or a motion task mode.

The communication unit 180 may connect the electronic apparatus 100 to an external apparatus (for example, a server) under the control of the controller 140. The controller 140 may download an application from an external apparatus connected through the communication unit 180 or perform web browsing. The communication unit 180 may provide at least one of Ethernet 181, wireless LAN 182, and Bluetooth 183.

The audio input unit 190 may receive a voice uttered by a user. The audio input unit 190 may convert the input voice signal into an electrical signal and output it to the controller 140. In this case, the audio input unit 190 may be a microphone. In addition, the audio input unit 190 may be internal to or external to the electronic apparatus 100. The audio input unit 190 which is provided externally from the electronic apparatus 100 may be connected via a cable or a wireless network.

The audio output unit 195 may output audio corresponding to a broadcast signal under the control of the controller 140. The audio output unit 195 may include at least one of a speaker 195a, a headphone output terminal 195b, and an S/PDIF output terminal 195c.

When a user voice is input from the audio input unit 190, the controller 140 may recognize the voice using a voice recognition module and a voice database. The voice recognition may be divided into isolated word recognition where each uttered word is separately recognized, continuous speech recognition where continuous words, continuous sentences, and conversational voice are recognized, and keyword spotting which is in between the isolated word recognition and the continuous speech recognition and detects and recognizes a predetermined keyword.

When a user voice is input, the controller 140 may determine a voice section by detecting the beginning and end of a voice uttered by a user within an input voice signal. The controller 140 may calculate the energy of the input voice signal, classify the energy level of the voice signal according to the calculated energy, and detect a voice section using dynamic programming. The control unit 140 may generate phoneme data by detecting a phoneme, which is the smallest unit of a voice, based on an acoustic model, in the voice signal within the detected voice section. The control unit 140 may generate text information by applying a Hidden Markov Model (HMM) to the generated phoneme data. However, the above method of recognizing a user voice is only an exemplary embodiment, and a user voice may be recognized using other methods. Accordingly, the controller 140 may recognize a user voice included in a voice signal.

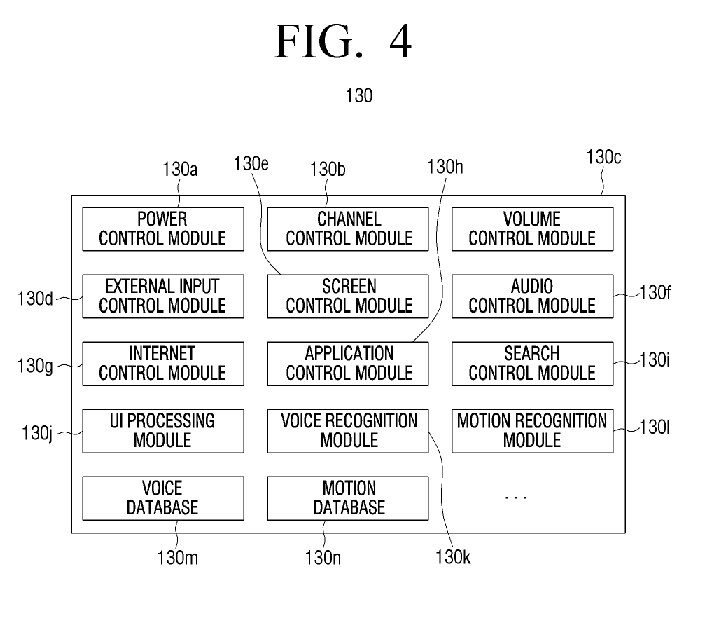

FIG. 4 is a view illustrating a configuration of software stored in storage according to an exemplary embodiment.

As illustrated in FIG. 4, the storage 130 may include a power control module 130a, a channel control module 130b, a volume control module 130c, an external input control module 130d, a screen control module 130e, an audio control module 130f, an Internet control module 130g, an application control module 130h, a search control module 130i, a UI processing module 130j, a voice recognition module 130k, a motion recognition module 1301, a voice database 130m, and a motion database 130n. Each of the modules 130a, 130b, 130c, 130d, 130e, 130f, 130g, 130h, 130i, 130j, 130k, and 1301 may be implemented as software that performs a power control function, a channel control function, a volume control function, an external input control function, a screen control function, an audio control function, an Internet control function, an application control function, a search control function, a UI processing function, a voice recognition function, and a motion recognition function, respectively. The controller 140 may perform the corresponding functions by executing the software stored in the storage 130.

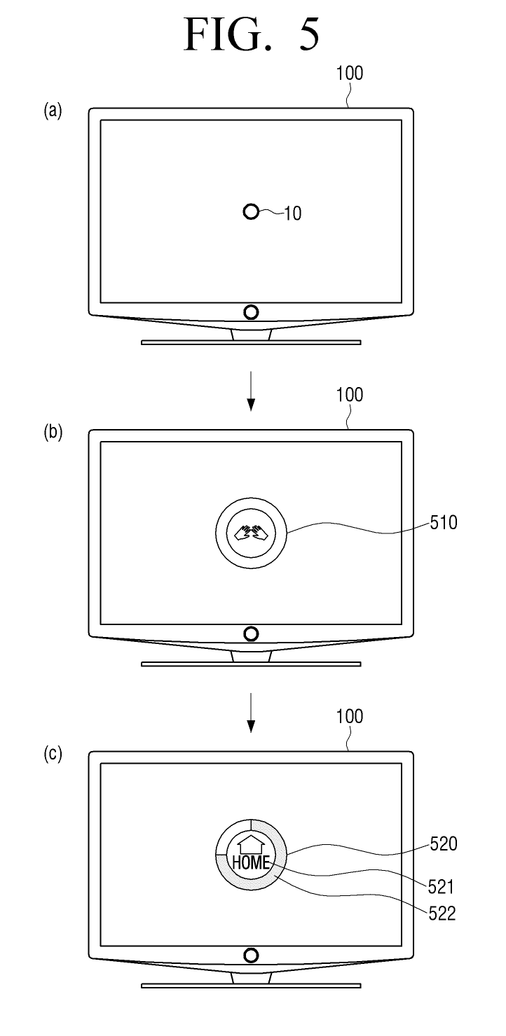

Hereinafter, the method for providing a UI according to various exemplary embodiments will be explained with reference to FIGS. 5, 6, and 7.

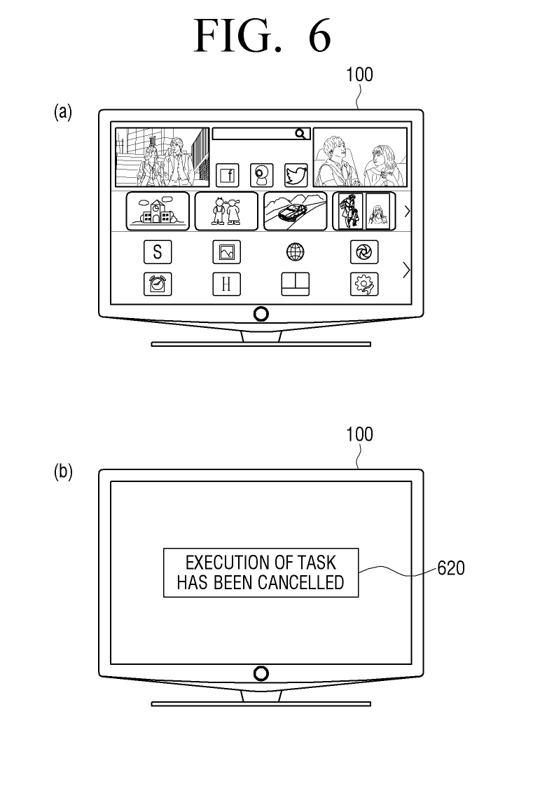

FIGS. 5 and 6 are views illustrating a method for providing a UI according to an exemplary embodiment.

As illustrated in FIG. 5(a), when a motion task mode is activated according to a predetermined event, a pointer 10 which is controlled by a motion may be displayed. Subsequently, when a user motion command is input, a first GUI element 510 which provides visual feedback regarding a recognized motion may be displayed as illustrated in FIG. 5(b). Accordingly, a user may check how his or her motion is recognized in the display apparatus 100.

In addition, as illustrated in FIG. 5(c), a second GUI element 520 which represents information regarding a motion task may be displayed in association with or subsequent to the first GUI element which provides visual feedback regarding a pose of a recognized motion. In this case, the second GUI element 520 may include an icon element 521 representing a function which will be executed according to the motion task. For example, if the function which will be executed according to recognized the motion is “moving to a home screen,” an icon element representing the home screen may be displayed.

In addition, the second GUI element 520 may further include a graphic element 522 representing a remaining time of a predetermined time until a motion task will be performed. In this case, the graphic element 522 may be configured to have an animation effect where the remaining time is reduced gradually.

Meanwhile, when the predetermined time elapses while an input motion is maintained, a motion task corresponding to the input motion is performed as illustrated in FIG. 6(a). For example, the motion task of “moving to the home screen” may be performed according to the input motion, and the home screen may be displayed.

Further, when an input motion is released (i.e., canceled) before a predetermined time has elapsed, a GUI 620 indicating that the execution of a motion task has been canceled may be displayed as illustrated in FIG. 6(b). For example, a message including “the execution of a task has been canceled” may be displayed.

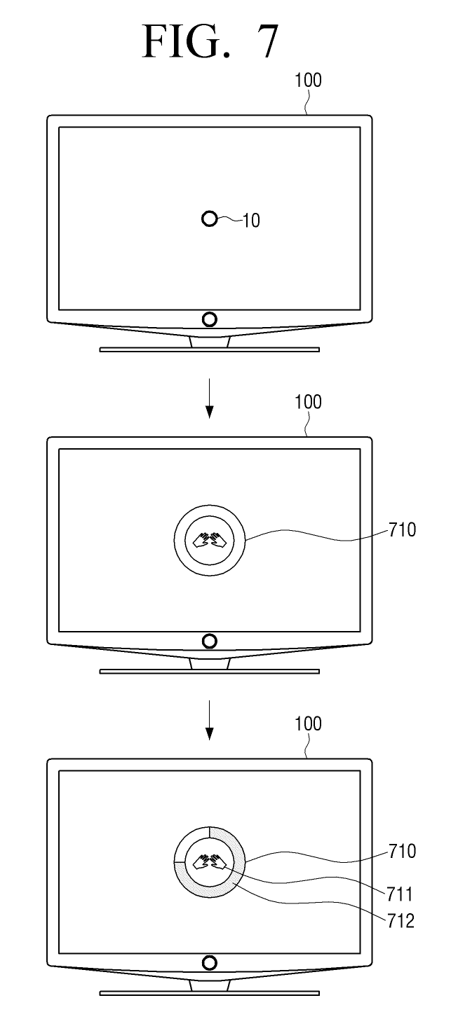

FIG. 7 illustrates a method for providing a UI according to another exemplary embodiment.

As illustrated in FIG. 7, when a motion task mode is activated according to a predetermined event, the pointer 10 which is controlled by a motion may be displayed.

Subsequently, when a user motion command is input, a first GUI element 710 which provides a visual feedback regarding a recognized motion may be displayed. Accordingly, a user may check how his or her motion is recognized in the display apparatus 100.

In this case, the first GUI element 710 may include not only a GUI 711 representing a recognized motion but also a GUI 712 representing a remaining time of the predetermined time until a function corresponding to the recognized motion is performed.

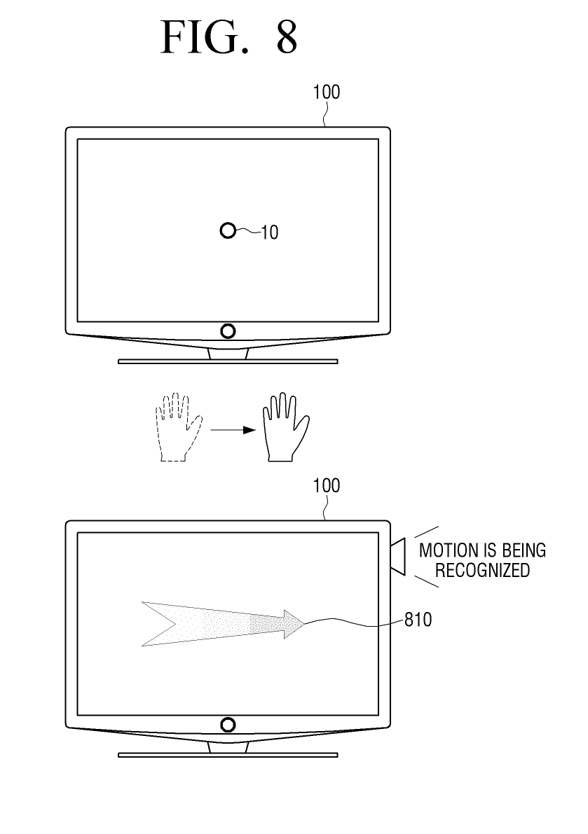

FIG. 8 illustrates a method for providing a UI according to another exemplary embodiment.

As illustrated in FIG. 8, when a motion task mode is activated according to a predetermined event, the pointer 10 which is controlled by a motion may be displayed. Subsequently, when a predetermined user motion is input, a UI indicating that further motion input will not be accepted for a predetermined time may be displayed. For example, when the slap motion of moving a hand in one direction at a speed that is higher than a predetermined speed is recognized, the display apparatus 100 may be configured not to receive any additional motion input for a predetermined time. In this case, a GUI 810 indicating that a motion is being recognized may be displayed, or a message indicating that a further motion input will not be accepted may be displayed in the form of a GUI or an audio message so as to inform a user of a standby time until further motion input will be accepted.

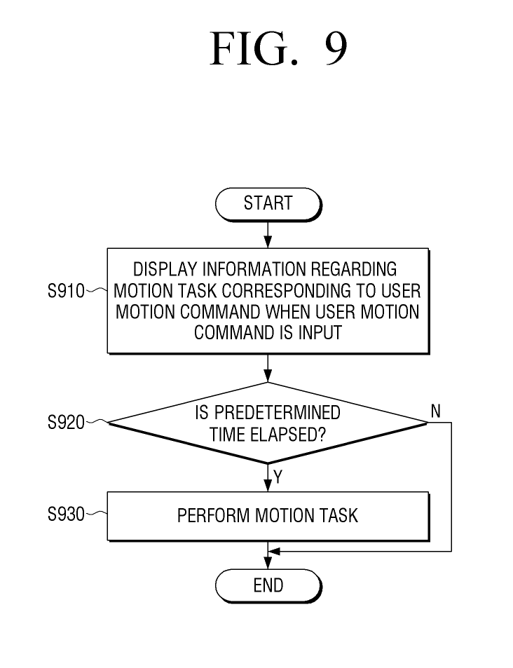

FIG. 9 is a flowchart illustrating a method for controlling an electronic apparatus according to an exemplary embodiment.

According to the method for controlling an electronic apparatus illustrated in FIG. 9, when a user motion command is input, information regarding a motion task corresponding to the user motion command is displayed (S910). Subsequently, when a predetermined time elapses (S920:Y), the corresponding motion task is performed (S930). Meanwhile, when the motion input according to the user motion command is maintained for a predetermined time in block S920, the motion task may be performed in block 930, after the predetermined time elapses.

When the motion input according to the user motion command is released before the predetermined time elapses in block S920 after the information regarding the motion task is displayed, the execution of the motion task may be canceled.

Further, in the step of S910, feedback regarding a remaining time of the predetermined time until the motion task is performed may be provided.

Further, when a user motion is input, the first GUI element which provides visual feedback regarding a pose of the recognized user motion may be displayed. In this case, in block S910, the second GUI element which represents information regarding a motion task may be displayed in association with or subsequent to the displayed first GUI element.

In this case, the second GUI element may include an icon representing a function which will be performed according to the motion task.

In addition, the second GUI element may further include a graphic element representing a remaining time of the predetermined time until the motion task will be performed.

Herein, the icon representing a function which will be performed according to the motion task may be displayed inside a circular GUI, and the graphic element representing a remaining time of the predetermined time until the motion task is performed may be displayed outside the circular GUI at the border area of the GUI.

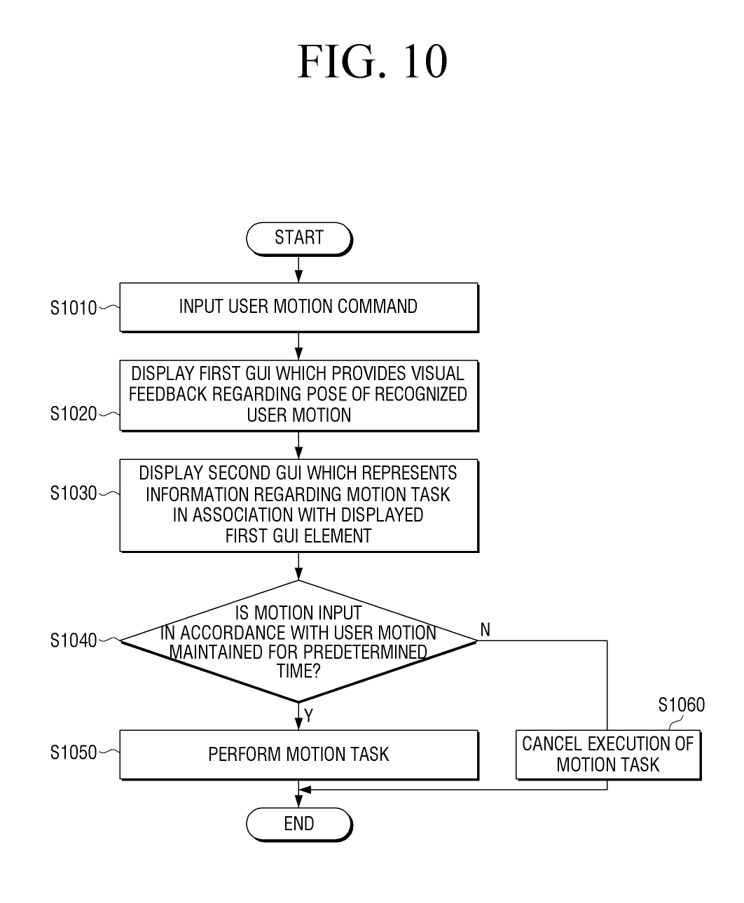

FIG. 10 is a flowchart illustrating a method for controlling an electronic apparatus according to another exemplary embodiment.

According to the method for controlling an electronic apparatus illustrated in FIG. 10, when a user motion command is input (S1010), the first GUI element which provides visual feedback regarding the recognized user motion is displayed (S1020).

Subsequently, the second GUI element representing information regarding a motion task is displayed in association with or subsequent to the displayed first GUI element (S1030).

Subsequently, when the motion input according to the user motion command is maintained for a predetermined time (S1040:Y), the motion task is performed after the predetermined time elapses (S1050).

On the other hand, when the motion input according to the user motion command is released before the predetermined time elapses after information regarding the motion task is displayed (S1040:N), the execution of the motion task may be canceled (S1060).

As described above, a user may be provided with information regarding a function which will be performed according to his or her motion in advance and thus, the user's cognitive anxiety may be reduced.

Meanwhile, the method for controlling an electronic apparatus according to the above-described various exemplary embodiments may be implemented as a program and provided in an electronic apparatus.

For example, a non-transitory computer readable medium storing a program which, when a user motion is input, displays information regarding a motion task corresponding to the user motion command, and when a predetermined time elapses after the information regarding the motion task is displayed, performs the motion task, may be provided.

Herein, the non-transitory computer readable medium refers to a medium which may store data semi-permanently rather than storing data for a short time, such as a register, a cache, and a memory, and may be readable by an apparatus. Specifically, the above-mentioned various applications or programs may be stored in a non-temporal recordable medium such as CD, DVD, hard disk, Blu-ray disk, USB, memory card, and ROM and provided therein.

The foregoing embodiments and advantages are merely exemplary and are not to be construed as limiting. The present teaching can be readily applied to other types of apparatuses. Also, the description of the exemplary embodiments intended to be illustrative, and not to limit the scope of the claims, and many alternatives, modifications, and variations will be apparent to those skilled in the art.

What is claimed is:

1. A method for controlling an electronic apparatus, the method comprising:
receiving a user motion command;
in response to the receiving the user motion command, displaying information regarding a motion task corresponding to the received user motion command; and
performing the motion task corresponding to the received user motion command after the information regarding the motion task has been displayed for a predetermined time.

2. The method according to claim 1, wherein the performing the motion task comprises, in response to a motion input corresponding to the user motion command being maintained until the predetermined time after the information regarding the motion task is displayed has elapsed, performing the motion task.

3. The method according to claim 1, further comprising:
in response to a motion input corresponding to the user motion command being released before the predetermined time after the information regarding the motion task is displayed has elapsed, canceling execution of the motion task.

4. The method according to claim 1, wherein the displaying the information regarding the motion task comprises providing feedback regarding a remaining time of the predetermined time after which the motion task will be performed.

5. The method according to claim 1, further comprising:
in response to the user motion command being input, displaying a first GUI element which provides visual feedback regarding a recognized user motion,
wherein the displaying the information regarding the motion task comprises displaying a second GUI element which represents the information regarding the motion task in association with the displayed first GUI element.

6. The method according to claim 5, wherein the second GUI element includes an icon representing a function which will be performed according to the motion task.

7. The method according to claim 6, wherein the second GUI element further comprises a graphic element representing a remaining time of the predetermined time after which the motion task will be performed.

8. The method according to claim 7, wherein the icon included in the second GUI is displayed inside a circular element, and the graphic element included in the second GUI is displayed outside the circular element at a border area of the circular element.

9. An electronic apparatus, comprising:
a motion input unit configured to receive a user motion command;
a display; and
a controller which, in response to the user motion command being received by the motion input unit, is configured to control the display to display information regarding a motion task corresponding to the user motion command received by the motion input unit and perform the motion task corresponding to the user motion command received by the motion input unit after the information regarding the motion task has been displayed for a predetermined time.

10. The apparatus according to claim 9, wherein the controller, in response to a motion input corresponding to the user motion command being maintained until the predetermined time after the information regarding the motion task is displayed has elapsed, is configured to perform the motion task.

11. The apparatus according to claim 9, wherein the controller, in response to a motion input corresponding to the user motion command being released before the predetermined time after the information regarding the motion task is displayed has elapsed, is configured to cancel execution of the motion task.

12. The apparatus according to claim 9, wherein the controller is configured to provide feedback regarding a remaining time of the predetermined time after which the motion task will be performed.

13. The apparatus according to claim 9, wherein the controller, in response to the user motion being input, is configured to display a first GUI element which provides visual feedback regarding a recognized user motion, and display a second GUI element which represents the information regarding the motion task in association with the displayed first GUI element.

14. The apparatus according to claim 13, wherein the second GUI element includes an icon representing a function which will be performed according to the motion task.

15. The apparatus according to claim 14, wherein the second GUI element further comprises a graphic element representing a remaining time of the predetermined time after which the motion task will be performed.

16. A non-transitory computer readable medium storing a program causing a computer to execute a method for controlling an electronic apparatus, the method comprising:
receiving a user motion command;
in response to the receiving the user motion command, displaying information regarding a motion task corresponding to the received user motion command; and
performing the motion task corresponding to the received user motion command after the information regarding the motion task has been displayed for a predetermined time.

17. The non-transitory computer readable medium according to claim 16, wherein the performing the motion task comprises, in response to a motion input corresponding to the user motion command being maintained until the predetermined time after the information regarding the motion task is displayed has elapsed, performing the motion task.

18. The non-transitory computer readable medium according to claim 16, further comprising:
in response to a motion input corresponding to the user motion command being released before the predetermined time after the information regarding the motion task is displayed has elapsed, canceling execution of the motion task.

19. The non-transitory computer readable medium according to claim 16, wherein the displaying the information regarding the motion task comprises providing feedback regarding a remaining time of the predetermined time after which the motion task will be performed.

20. The non-transitory computer readable medium according to claim 16, further comprising:
in response to the user motion command being input, displaying a first GUI element which provides visual feedback regarding a recognized user motion,
wherein the displaying the information regarding the motion task comprises displaying a second GUI element which represents the information regarding the motion task in association with the displayed first GUI element.
